(19) United States
(12) Patent Application Publication
(10) Pub. No.: US 2009/0041575 A1
(43) Pub. Date: Feb. 12, 2009

(54) Driving Apparatus for a Wave Power Device

(76) Inventor: Paul K. Morch, Kopervik (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/817,471

(22) PCT Filed: Mar. 1, 2006
(86) PCT No.: PCT/NO2006/000078

§ 371 Date: Aug. 8, 2008

(30) Foreign Application Priority Data
Mar. 2, 2005 (NO) 20051125
Dec. 21, 2005 (NO) 20056078

(51) Int. Cl. F03B 13/22; F04B 35/02; F03B 13/10

(52) U.S. Cl. 415/124.1; 417/330; 290/53

(57) ABSTRACT

Driving apparatus for a wave power device, in which a turbine is placed in a substantially stationary open tubular element, the tubular element extending through the water surface into the water, and in which the amount of water flowing into and out of the tubular element due to a varying wave height around the tubular element, has to pass the turbine; alternatively, the tubular element being placed substantially horizontally below the water surface, a flow of water passing through it, the turbine being connected to a supported turbine shaft, and the turbine shaft being provided with a co-rotating eccentric part, the eccentric part being surrounded by a freely rotatable eccentric bearing connected to the eccentric part, and the eccentric bearing forming the driving part of a fluid pump.

This invention relates to driving apparatus for a wave power device. More particularly, it concerns a wave power device, in which a turbine is placed in an open tubular element, the tubular element extending down through the water surface into the water, and in which the amount of water flowing into and out of the tubular element due to a varying wave height around the tubular element, has to pass the turbine. Alternatively, the tubular element is placed substantially horizontally below the water surface, where water is flowing though it. The turbine is connected to a supported turbine shaft, the turbine shaft being provided with a co-rotating eccentric part. The eccentric part is surrounded by a freely rotatable eccentric bearing connected to the eccentric part, so that the eccentric bearing forms the driving part of a fluid pump.

Over a relatively long time wave power devices have been developed, which are arranged to utilize the relatively great energy density existing in ocean waves.

However, due to the great strains that such facilities are subjected to, it has turned out to be difficult to build reliable and durable wave power devices for use in the open sea.

The invention has as its object to remedy or reduce at least one of the drawbacks of the prior art.

The object is achieved according to the invention through the features specified in the description below and in the Claims that follow.

A turbine which may have a vertical axis of rotation is placed in a substantially stationary open tubular element. The tubular element extends through the water surface into the water, the amount of water flowing into and out of the tubular element due to a varying wave height around the tubular column, having to pass the turbine. Alternatively, the tubular element is placed substantially horizontally below the water surface, where water is flowing though it.

The turbine is connected to a supported turbine shaft, the turbine shaft being provided with a co-rotating eccentric part. The eccentric part is surrounded by a rotatable eccentric bearing freely connected to the eccentric part, the eccentric bearing forming the driving part of a fluid pump.

The turbine shaft may be provided with individual radial and axial bearings. Alternatively the bearings may be integrated into a sleeve.

The fluid pump includes at least one pump cylinder which is connected at its one end portion to the eccentric bearing and which is connected at its other end portion to a stationary portion.

The pump cylinder is provided with one-way valves and receives fluid supplied from a reservoir and delivers pressurized fluid to an accumulator. The accumulator communicates with a fluid motor which is further connected to and drives an electric generator.

In a relatively simple manner the wave power device according to the invention may be connected to a deep-running and thereby substantially stationary floating or fixed installation.

In what follows, there is described a non-limiting example of a preferred embodiment which is visualized in the accompanying drawings, in which:

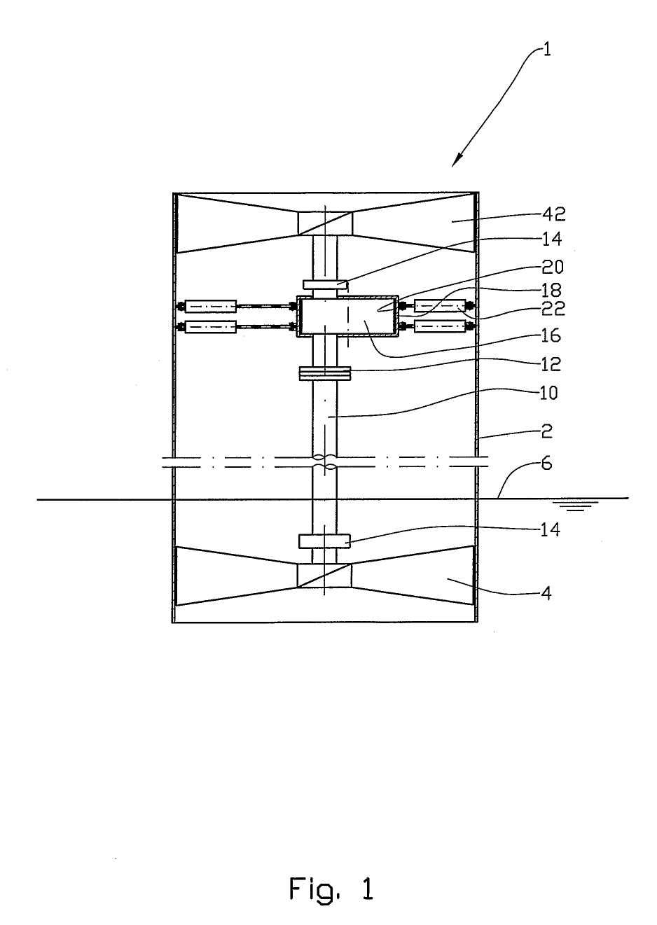

FIG. 1 shows in a vertical section a principle drawing of the wave power device according to the invention;

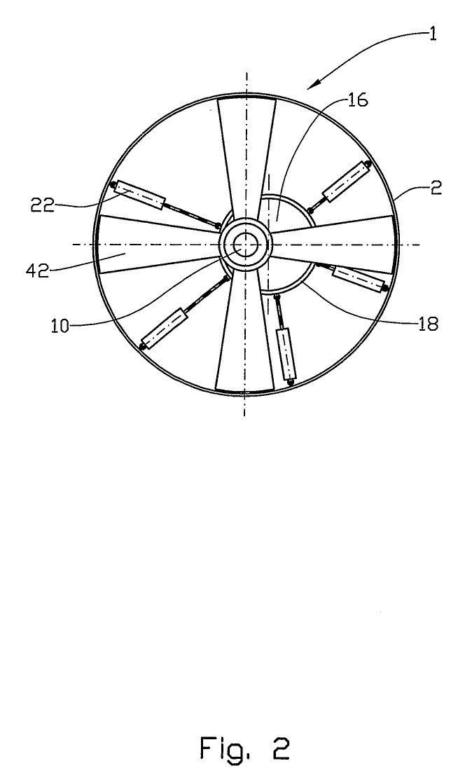

FIG. 2 shows a plan view of the wave power device of FIG. 1;

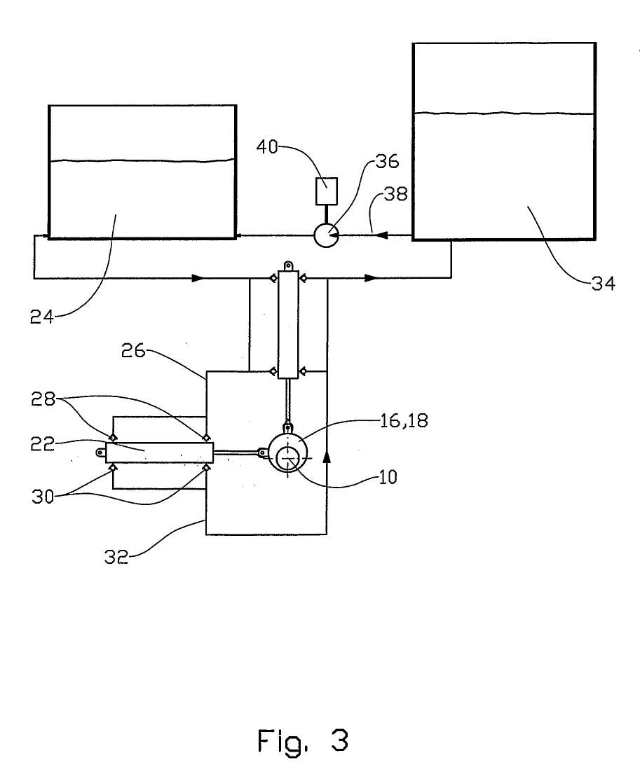

FIG. 3 shows a circuit diagram for the pump part of the wave power device; and

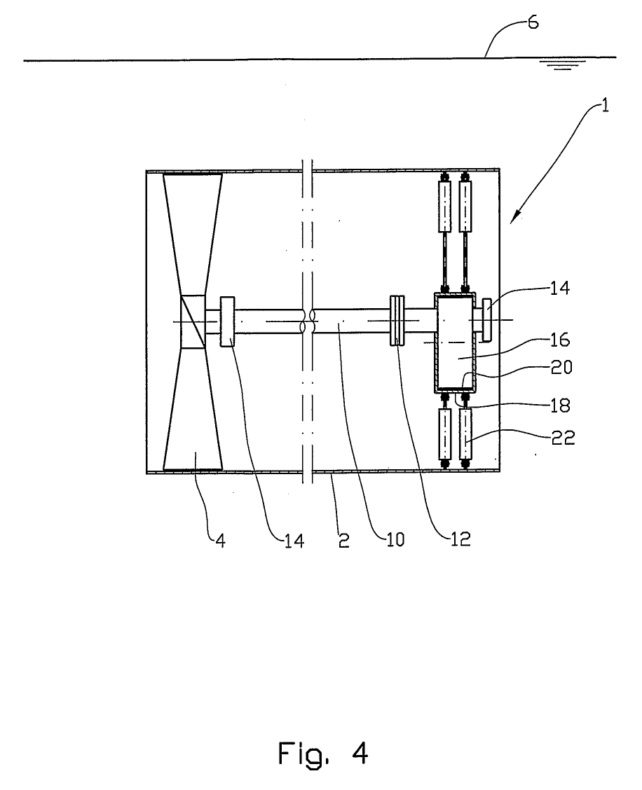

FIG. 4 shows an alternative embodiment, in which the wave power device is placed, horizontally submerged, in the sea.

In the drawings the reference numeral 1 indicates a wave power device including a vertical tubular element 2 and a turbine 4.

The tubular element 2, which is substantially stationary, may be connected to a vessel, not shown, or a fixed installation, and extends through the water surface 6 into the water.

The turbine 4 is connected to a turbine shaft 10 supported in a thrust bearing 12 and two radial bearings 14. The bearings 12, 14 are connected to the tubular element 2 by way of supporting structures, not shown.

An eccentric part 16 is connected to and co-rotates with the turbine shaft 10. The eccentric part 16 is surrounded by an eccentric bearing 18 freely rotatable relative to the eccentric part 16. A radial bearing 20 absorbs the radial forces between the eccentric part 16 and the eccentric bearing 18.

A number of pump cylinders 22 extend radially between the eccentric bearing 18 and the tubular element 2. The pump cylinders 22 are articulatingly mounted. The eccentric bearing 18 is prevented from being rotatable.

The pump cylinders 22 receive fluid supplied from a reservoir 24 through a supply pipe 26 and one-way inlet valves 28. From the pump cylinders 22 pressurized fluid flows through one-way pressure valves 30 and a pressure tube 32 to an accumulator 34. Arrows in FIG. 3 indicate the direction of flow.

The pump cylinders 22 together with pipes and valves 26, 28, and 32 thus constitute a fluid pump.

From the accumulator 34 pressurized fluid flows to a fluid motor 36 and on to the reservoir 24 through an intermediate pipe 38. The fluid motor 36 is connected to an electric generator 40.

When the water within the tubular element 2 rises, rotation is imparted to the turbine 4 in one direction. The eccentric part 16, which rotates within the eccentric bearing 18, thereby makes the pump cylinders 22 pump pressurized fluid to the accumulator 34.

When the water in the tubular element 2 sinks, rotation is imparted to the turbine 4 in the opposite direction. However, the pump cylinders 22 work independently of the direction of rotation of the eccentric part 16. The pump cylinders 22 are double-acting.

The stored pressurized fluid present in the accumulator 34 flows through the intermediate pipe 38 to the fluid motor 36, in which the pressurized fluid, before flowing on to the reservoir 24, gives off most of its pressure energy. The fluid motor 36 drives the electric generator 40.

The accumulator 34 ensures an even flow of pressurized fluid to the fluid motor 36.

If desirable, the turbine shaft 10 may be provided, at its upper portion, with a wind turbine 42 to utilize the air flow passing through the upper portion of the tubular element 2 as a consequence of the wave motion.

In an alternative embodiment, see FIG. 4, the tubular element 2 is submerged and the water flows horizontally through the tubular element. Its operation corresponds to that explained above, with the exception of the water flow through the tubular element 2 being unidirectional.

1. Driving apparatus for a wave power device, in which a turbine is placed in a substantially stationary open tubular element, the tubular element extending through the water surface into the water, and in which the amount of water flowing into and out of the tubular element due to a varying wave height around the tubular element has to pass the turbine; alternatively, the tubular element being placed substantially horizontally below the water surface, a flow of water passing through it, the turbine being connected to a supported turbine shaft, characterized in that the turbine shaft is provided with a co-rotating eccentric part, the eccentric part being surrounded by a freely rotatable eccentric bearing connected to the eccentric part and the eccentric bearing forming the driving part of a fluid pump.

2. The driving apparatus in accordance with claim 1, characterized in that the fluid pump includes at least one pump cylinder, which is connected at its one end portion to an eccentric bearing and is connected at its other end portion to a stationary portion.

3. The driving apparatus in accordance with claim 1, characterized in that the pump cylinder is double-acting.

4. The driving apparatus in accordance with claim 1, characterized in that by way of one-way valves the pump cylinder is provided with fluid and supplies fluid to an accumulators.

5. The driving apparatus in accordance with claim 1, characterized that the accumulator communicates with a fluid motor which is further connected to and drives an electric generators.
